(19) United States
(12) Patent Application Publication
(10) Pub. No.: US 2021/0056504 A1
(43) Pub. Date: Feb. 25, 2021

(54) SYSTEMS AND METHODS FOR CONSOLIDATING TRACKING AND DELIVERY OF SHIPPED PARCELS

(71) Applicant: E.BOXSECURE LLC, Carmel, IN (US)

(72) Inventor: Zachary B. Scott, Carmel, IN (US)

(21) Appl. No.: 16/999,918

(22) Filed: Aug. 21, 2020

Related U.S. Application Data
(60) Provisional application No. 62/889,741, filed on Aug. 21, 2019.

(51) Int. Cl. G06Q 10/08; G06Q 30/00

(52) U.S. Cl. CPC G06Q 10/0833; G06Q 10/08355; G06Q 30/018; G06Q 10/0838; G06Q 10/0836

(57) ABSTRACT

Improved data communications and processing systems and methods for consolidating tracking and delivery of shipped parcels is provided. The systems enable selective consolidation of carrier delivery of parcels for multiple customers to receiving agent locations in accordance with each customer's selection of a receiving agent location during checkout on a third-party vendor's website. A customer enrollment module and vendor ordering system API enables the customer to manage parcels shipped by multiple vendors and delivered by multiple carriers. A receiving agent location enrollment module enables the receiving agent location to receive parcels for multiple customers delivered by multiple carriers and shipped by multiple ecommerce and other vendors. Customers may further manage their parcel delivery, including locations, and access current and historical data. Receiving agent locations select and display historic, current, and forecast data relating to parcels from multiple vendors, carriers, and customers.

### RELATED APPLICATIONS

This application claims the benefit of U.S. Provisional Application No. 62/889,741, filed Aug. 21, 2019, which is hereby incorporated herein by reference.

### TECHNICAL FIELD

Embodiments of this disclosure relate generally to data communication and processing systems for managing the shipment of parcels, and more particularly to data communication processing systems for managing the delivery of shipped parcels.

### BACKGROUND

The explosive growth of ecommerce, i.e. online shopping and other internet enabled consumer transactions, has driven an increased demand on delivery logistics, particularly on business to consumer logistics such as parcel deliveries to low density delivery areas such as direct to door parcel deliveries in residential areas. Competitive pressure to keep delivery costs low and the increasing lack of sufficient delivery labor, particularly during seasonal peaks such as Christmas, has made it difficult for parcel carriers to meet the increasing demand.

Present technical solutions to assist ecommerce customers and others with managing the tracking and delivery of shipped parcels have many technological shortcomings.

For example, present technical solutions do not provide consolidated tracking of ecommerce transactions and shipped parcels. Electronic platforms are vendor or carrier specific. For example, specific vendors provide website enabled user accounts that allow customers to login and determine whether an order has been fulfilled and shipped, but that generally do not provide information about the status of an order once the parcel is in transit. A tracking number provided by the carrier to the vendor can be obtained by the customer to then use with a carrier specific platform, such as a carrier website that is separate from that of the vendor, to track the shipped parcel.

Additionally, even if a specific vendor platform has a data interface with one or more carriers to provide customers with information regarding the status of a shipped parcel, most consumers do business with more than one ecommerce vendors, for example, ordering from separate ecommerce websites. As competitors, the vendor platforms lack a common data interface from which a consumer can obtain the status of orders and/or shipped parcels originating from separate ecommerce websites. Similarly, carriers of parcels shipped by ecommerce vendors lack a common data interface from which a consumer can obtain the status of shipped parcels being transported by different carriers. Therefore, typical ecommerce customers must access and/or enroll in each separate vendor and platform, making it difficult to view and manage ecommerce transactions and associated parcels.

Another drawback of this stove-piping of separate electronic platforms to view and manage shipped parcels originating from various different vendors and transported by various carriers is that for a moderate to heavy ecommerce consumer, the multitude of logistics streams results in parcels being delivered one at a time during any given day by each different carriers and day after day during any given week arriving from each different vendor. With prior art electronic platforms that are separate and that lack data or management integration, consumers are not able to control or coordinate the date and time of delivery of parcels.

Because of these and other problems, some ecommerce vendors and also parcel carriers have been struggling to provide a comprehensive solution to reduce delivery cost to complete the last mile of the delivery process. One solution offered by some ecommerce vendors that have a large network of retail locations is to provide in-store pickup, which reduces the labor and cost of the last mile delivery and provides a secure location to hold the parcels for pickup; however, for ecommerce customers ordering from ecommerce websites of a number of different retailers, coordinating the pickup locations and dates is logistically challenging, particularly when no one electronic platform provides up-to-date arrival status of orders. The customer must log into separate websites associated with each vendor or look for separate status emails or other separate notifications of the status and availability of parcels for pickup.

Another solution offered by some carriers and by some third-party service providers is a retail location which a customer may contract with to have all of their parcels delivered and held for pickup. However, such locations only receive parcels from one or fewer than all carriers. Additionally, the service is analogous to having a post office box and does not provide flexibility or ease in changing that delivery location. Because a delivery location for pickup is contracted for many months at a time, and because of a lack of online processes for initiating or changing contracting, the consumer typically must make a physical visit to the delivery location to contract a new delivery location, or at least have specific engagement with an employee of that delivery location along with providing that employee with all necessary information and payment arrangements to initiate or change a delivery location, providing neither ease or flexibility in delivery location for parcels. Furthermore, because of the lack of data integration with various parties, the status of parcels being delivered to the established retail location is not available from multiple vendors and potentially multiple carriers without having to separately check the specific platforms of each of the vendors and/or carriers.

One prior art solution providing a more flexible delivery location is offered by a specific ecommerce platform, namely, automated self-help locker kiosks in popular locations accessible by the public, for example, retail locations; however, only orders made using that specific ecommerce platform can be directed to a selected locker location and only the specific ecommerce platform's preferred carrier has access to and can deliver parcels to the selected locker location, thus requiring consumers ordering from other vendors and/or using other carriers to arrange for parcel delivery in at least one other location in addition to their selected locker location.

While the above prior solutions do help to reduce the last mile delivery costs for some ecommerce vendors and carriers; customers still lack a technical solution that provides access and visibility across all their ecommerce activity because of lack of data integration or management integration between prior art systems. Additionally, these shortcomings of prior electronic platforms cause customers a lack of flexibility to easily change a delivery location for all vendors and for all carriers.

Consequently, it was realized by the inventor of the current disclosure that existing parcel shipping management data communication systems and methods have numerous shortcomings that fail to meet the needs of increasingly high volume of ecommerce transactions and parcel shipments and the needs of the consumers initiating the transactions and that improvements in those data communication and processing systems and methods are needed. The current disclosure addresses the need for technology-based data communication and processing systems which address these and other technical shortcomings.

### SUMMARY

Embodiments of the present disclosure provide improved systems and methods for consolidating routing, tracking and delivery of shipped parcels. The data communication and processing systems and method selectively consolidate carrier delivery of parcels for multiple customers to receiving agent locations in accordance with each one of the customer's selection of a receiving agent location. The system can include a secure database and at least one processor executes various application modules. A single customer enrollment can enable the customer to manage parcels shipped by multiple vendors and delivered by multiple carriers. A single receiving agent location enrollment can enable the receiving agent location to receive parcels for multiple customers delivered by multiple carriers and shipped by multiple ecommerce and other vendors. A data interface can be provided to carrier data systems and to vendor data systems. Customers can further manage their parcel delivery, directing and redirecting delivery locations, timing, and access current and historical data. Receiving agent locations can select and display historic, current, and forecast data relating to parcels from multiple vendors, carriers, and customers.

At least one illustrative embodiment of a data communication or processing system for managing parcel shipments for a plurality of customers and a plurality of receiving agent locations, can comprise a secure database comprising data structures for storing data relevant to the parcel shipments, the plurality of customers, and plurality of receiving agent locations and at least one processor executing various modules. A customer enrollment module can be capable of enrolling a plurality of customers each located in one of a plurality of low density parcel locations. A receiving agent location enrollment module can be capable of enrolling a plurality of receiving agent locations each located in the vicinity of at least one of the plurality of low density parcel location. A status module can include an interface with a plurality of carrier data systems. A vendor module can include an interface with a plurality of vendor data systems of vendors shipping goods in parcels by one or more carriers.

A customer management module can enable each of the plurality of customers to manage parcels shipped by a plurality of vendors and delivered by a plurality of carriers; select a preferred subset of the plurality of receiving agent locations; specify for at least a period of time one of the preferred subset of the plurality of receiving agent locations to have the parcels shipped to; locate the closest one of the plurality of receiving agent locations to a specified location; schedule a date and time to pick up the parcel at the one of the preferred subset; review parcel status and history; review vendor order history; and direct forwarding of parcels from the one of the preferred subset to a specified delivery location.

A receiving agent location management module can enable each of the receiving agents to display inbound parcels and received parcels from the plurality of vendors and the plurality of carriers; display scheduled pickups of parcels by the plurality of customers; and authenticate code for pickup of parcels.

An illustrative embodiment of the system can thereby selectively consolidate carrier delivery of parcels for the plurality of customers to the plurality of receiving agent locations.

The customer enrollment module can enable a single enrollment of one of the plurality of customers to manage parcels shipped by the plurality of vendors and delivered by the plurality of carriers. The receiving agent location enrollment module can enable a single enrollment for one of the plurality of receiving agent locations to receive parcels for the plurality of customers delivered by the plurality of carriers and shipped by the plurality of vendors.

An ecommerce module operating in conjunction with a customer ordering system of at least one of the plurality of vendors can enable the plurality of customers to select for an order the tracking and management of the delivery by the system for managing parcel shipments; and can enable login for an order using a customer login for the system for managing parcel shipments.

At least one other illustrative embodiment of a system for managing parcel shipments for a plurality of customers and a plurality of receiving agent locations, can comprise a secure database comprising data structures for storing data relevant to the parcel shipments, the plurality of customers, and plurality of receiving agent locations; at least one processor executing various modules. A customer enrollment module can be capable of enrolling a plurality of customers each located in one of a plurality of low density parcel locations, and can enable a single enrollment of one of the plurality of customers to manage parcels shipped by the plurality of vendors and delivered by the plurality of carriers, and selection by each of the plurality of customers of a preferred one of the plurality of receiving agent locations to receive delivery of parcels. A receiving agent location enrollment module for enrolling a plurality of receiving agent locations each located in the vicinity of at least one of the plurality of low density parcel locations can enable a single enrollment for one of the plurality of receiving agent locations to receive parcels for the plurality of customers delivered by the plurality of carriers and shipped by the plurality of vendors.

A carrier module can include an interface with a plurality of carrier data systems. A vendor module can include an interface with a plurality of vendor data systems of vendors shipping goods in parcels by one or more carriers.

A customer management module can enable each of the plurality of customers to manage parcels shipped by a plurality of vendors and delivered by a plurality of carriers. A receiving agent location management module can enable each of the receiving agents to display inbound parcels and received parcels from the plurality of vendors and the plurality of carriers. An illustrative embodiment of the system can thereby selectively consolidate carrier delivery of parcels for the plurality of customers to the plurality of receiving agent locations in accordance with each one of the plurality of customers selection of one of the plurality of receiving agent locations.

At least one illustrative method for managing parcel shipments for a plurality of customers and a plurality of receiving agent locations, can comprise the steps of providing a secure database comprising data structures for storing data relevant to the parcel shipments, the plurality of customers, and plurality of receiving agent locations; enrolling a plurality of customers each located in one of a plurality of low density parcel locations; enrolling a plurality of receiving agent locations each located in the vicinity of at least one of the plurality of low density parcel locations; providing a data interface with a plurality of carrier data systems; and providing a data interface with a plurality of vendor data systems of vendors shipping goods in parcels by one or more carriers. Each of the plurality of customers can manage parcels shipped by a plurality of vendors and delivered by a plurality of carriers; select a preferred subset of the plurality of receiving agent locations; specify for at least a period of time one of the preferred subset of the plurality of receiving agent locations to have the parcels shipped to; schedule a date and time to pick up the parcel at the one of the preferred subset; direct forwarding of parcels from the one of the preferred subset to a specified delivery location; and locate the closest one of the plurality of receiving agent locations to a location specified by the one of the plurality of customers;

The illustrative method can also display parcel status and history for each of the plurality of customers; display vendor order history for each of the plurality of customers; and display inbound parcels and received parcels from the plurality of vendors and the plurality of carriers for each of the plurality of receiving agent locations; display a schedule of pickups of parcels by the plurality of customers for each of the plurality of receiving agent locations; and authenticate codes for pickup of parcels by each of the plurality of customers.

The illustrative method can thereby selectively consolidates carrier delivery of parcels for the plurality of customers to the plurality of receiving agent locations in accordance with the one of the preferred subset of the plurality of receiving agent locations to have the parcels shipped to specified by each of the plurality of customers.

A step of enrolling a plurality of customers can enable a single enrollment of one of the plurality of customers to manage parcels shipped by the plurality of vendors and delivered by the plurality of carriers. A step of enrolling a plurality of receiving agent locations can enable a single enrollment for one of the plurality of receiving agent locations to receive parcels for the plurality of customers delivered by the plurality of carriers and shipped by the plurality of vendors.

The steps of one of the plurality of customers accessing a customer ordering system of at least one of the plurality of vendors can include selecting for an order the delivery management by the system for managing parcel shipments; and logging in for an order using a customer login for the system for managing parcel shipments.

At least one other method for managing parcel shipments for a plurality of customers and a plurality of receiving agent locations, can comprise the steps of providing a secure database comprising data structures for storing data relevant to the parcel shipments, the plurality of customers, and plurality of receiving agent locations; enrolling a plurality of customers each located in one of a plurality of low density parcel locations, each of the plurality of customers selecting a preferred one of the plurality of receiving agent locations to receive delivery of parcels; enrolling a plurality of receiving agent locations each located in the vicinity of at least one of the plurality of low density parcel locations; providing a data interface with a plurality of carrier data systems; providing a data interface with a plurality of vendor data systems of vendors shipping goods in parcels by one or more carriers; each of the plurality of customers managing parcels shipped by a plurality of vendors and delivered by a plurality of carriers; and displaying inbound parcels and received parcels from the plurality of vendors and the plurality of carriers for each of the plurality of receiving agent locations.

The illustrative method can thereby selectively consolidate carrier delivery of parcels for the plurality of customers to the plurality of receiving agent locations in accordance with the selected preferred one of the plurality of receiving agent locations to have the parcels shipped to specified by each of the plurality of customers.

This summary is provided to introduce a selection of the concepts that are described in further detail in the detailed description and drawings contained herein. This summary is not intended to identify any primary or essential features of the claimed subject matter. Some or all of the described features may be present in the corresponding independent or dependent claims, but should not be construed to be a limitation unless expressly recited in a particular claim. Each embodiment described herein does not necessarily address every object described herein, and each embodiment does not necessarily include each feature described. Other forms, embodiments, objects, advantages, benefits, features, and aspects of the present disclosure will become apparent to one of skill in the art from the detailed description and drawings contained herein. Moreover, the various apparatuses and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

Some of the figures shown herein may include dimensions or may have been created from scaled drawings. However, such dimensions, or the relative scaling within a figure, are by way of example, and not to be construed as limiting.

FIG. 1 illustrates example prior art systems and logistics flow for shipment of parcels;

FIG. 2 is an illustrative system for consolidating tracking and delivery of parcels, according to the present disclosure;

FIG. 3 is a parcel management data system portion of the illustrative system of FIG. 2;

FIG. 4 is an illustrative method for consolidating tracking and delivery of parcels, according to the present disclosure, that can be associated with the parcel management data system of FIG. 3;

FIG. 5 is an illustrative method of agent location enrollment for the illustrative method of FIG. 4;

FIG. 6 is an illustrative method of customer enrollment for the illustrative method of FIG. 4;

FIG. 7 is an illustrative method of ordering from a vendor for the illustrative method of FIG. 4;

FIG. 8 is an illustrative method of customer management for the illustrative method of FIG. 4;

FIG. 9 is an illustrative method of agent location management for the illustrative method of FIG. 4;

FIGS. 10-11 depict illustrative graphic user interfaces (GUI) associated with the parcel management data system of FIG. 3 and the customer enrollment method of FIG. 6;

FIG. 12 depicts an illustrative GUI associated with the parcel management data system of FIG. 3, the customer enrollment method of FIG. 6, and the customer management method of FIG. 8;

FIGS. 13-14 depict GUIs associated with the parcel management data system of FIG. 3 and the customer management method of FIG. 8;

FIG. 15A-B depict illustrative API enabled GUIs associated with the parcel management data system of FIG. 3, vendor data system of FIG. 2, and the vendor order method of FIG. 7;

FIGS. 16-18 depict illustrative GUIs associated with the parcel management data system of FIG. 3 and the location management method of FIG. 9; and

FIGS. 19A-22 depict illustrative GUIs associated with the parcel management data system of FIG. 3, the location management method of FIG. 9, and an executive management module of FIG. 3.

### DETAILED DESCRIPTION OF THE ILLUSTRATED EMBODIMENTS

For the purposes of promoting an understanding of the principles of the disclosure, reference will now be made to one or more embodiments, which may or may not be illustrated in the drawings, and specific language will be used to describe the same. It will nevertheless be understood that no limitation of the scope of the disclosure is thereby intended; any alterations and further modifications of the described or illustrated embodiments, and any further applications of the principles of the disclosure as illustrated herein are contemplated as would normally occur to one skilled in the art to which the disclosure relates. At least one embodiment of the disclosure is shown in great detail, although it will be apparent to those skilled in the relevant art that some features or some combinations of features may not be shown for the sake of clarity.

Any reference to “invention” within this document is a reference to an embodiment of a family of inventions, with no single embodiment including features that are necessarily included in all embodiments, unless otherwise stated. Furthermore, although there may be references to benefits or advantages provided by some embodiments, other embodiments may not include those same benefits or advantages, or may include different benefits or advantages. Any benefits or advantages described herein are not to be construed as limiting to any of the claims.

Likewise, there may be discussion with regards to “objects” associated with some embodiments of the present invention, it is understood that yet other embodiments may not be associated with those same objects, or may include yet different objects. Any advantages, objects, or similar words used herein are not to be construed as limiting to any of the claims. The usage of words indicating preference, such as “preferably,” refers to features and aspects that are present in at least one embodiment, but which are optional for some embodiments.

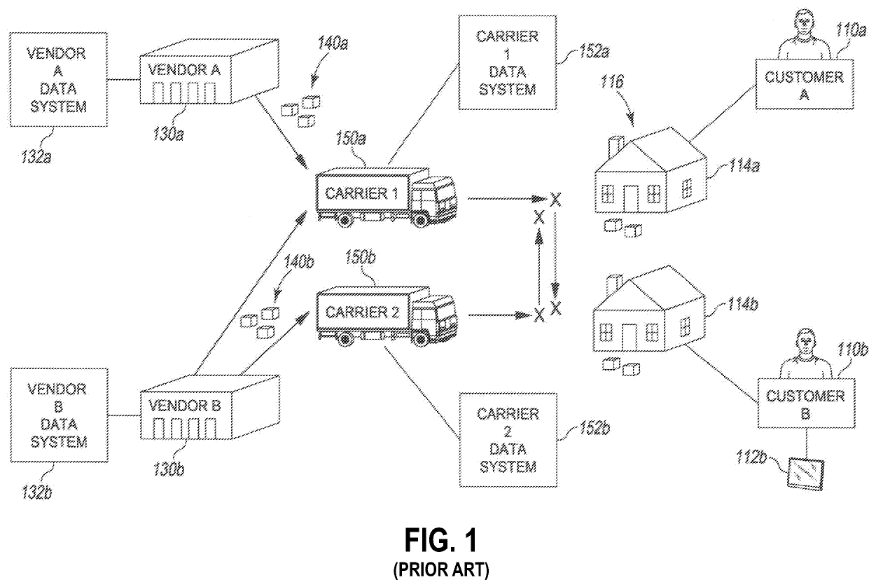

Referring to FIG. 1, example prior art systems and logistics flow 100 for shipment of parcels 140. In the example prior art system 100, customers 110a-b use computing devices 112, for example a smart phone, a table, or computer, to place orders from ecommerce vendors 130a-b for delivery to their residence 114a-b. The first order placed by customer 110a from vendor 130a is packaged in some of parcels 140a and transported by carrier 150a and delivered to the customer's residence 114a. In order to obtain information about the order and status of parcel 140a delivery, the customer 110a will need to separately access vendor data system 132a and carrier data system 152a. If the customer 110a places a second order from vendor 130b, the order is packaged in some of parcels 140b and one or more parcels are transported by carrier 150a and one more other parcels are transported by carrier 150b. To obtain information about this second order and the status of delivery of parcels 140b, the customer 110a will need to separately access vendor data system 132b, carrier data system 152a, and carrier data system 152b. The parcels 140a and 140b are delivered to the customer's residence 114a by carriers 150a and 150b, likely on different days, and quite likely even by separate trucks on separate days by one or both of carrier 150a and 150b, particularly for the parcels 140a and 140b from different vendors 130a-b that are both transported by carrier 150a. (For the brevity and simplicity, likely stops and transfer at logistics depots of each carrier 150a-b and possible multiple warehouses of each vendor 130a-b have been omitted.)

Additionally, if customer 110b places a third order from vendor 130a, it is packaged in some of parcels 140a and transported by carrier 150a and delivered to the customer's residence 114b. In order to obtain information about the order and status of parcel 140a delivery, the customer 110b will need to separately access vendor data system 132a and carrier data system 152a. If the customer 110b places a forth order from vendor 130b, the order is packaged in some of parcels 140b and one or more parcels are transported by carrier 150a and one more other parcels are transported by carrier 150b. To obtain information about this second order and the status of delivery of parcels 140b, the customer 110b will need to separately access vendor data system 132b, carrier data system 152a, and carrier data system 152b.

As with the deliveries to residence 114a, parcels 140a and 140b are delivered to the customer's residence 114b by carriers 150a and 150b, likely on different days, and quite likely even by separate trucks on separate days by one or both of carrier 150a and 150b, particularly for the parcels 140a and 140b from different vendors 130a-b that are both transported by carrier 150a. Depending on the relative timing of orders one, two, three, and four and type of shipping service selected, the packages for both of parcels 140a and 140b to residences 114a and 114b may or may not be on the same delivery day and delivery truck for either of carrier 150a and 150b. These type of delivery patterns exacerbate the low density of deliver area 116 for carriers 150a-b in which the residences 114a-b are located, adding labor and costs to the delivery of parcels 140a and 140b, particularly with the increasingly quantity of ecommerce parcels being delivered to low density delivery areas 116 and without consolidation as to delivery date, packaging of parcels, and/or transporting and delivering carriers. Additional and alternative aspects of example prior art systems 100 include aspects discussed in the Background section above which also add to the shortcomings for customers, including lack of consolidation of deliveries and information, lack of convenience, and increasing labor and costs.

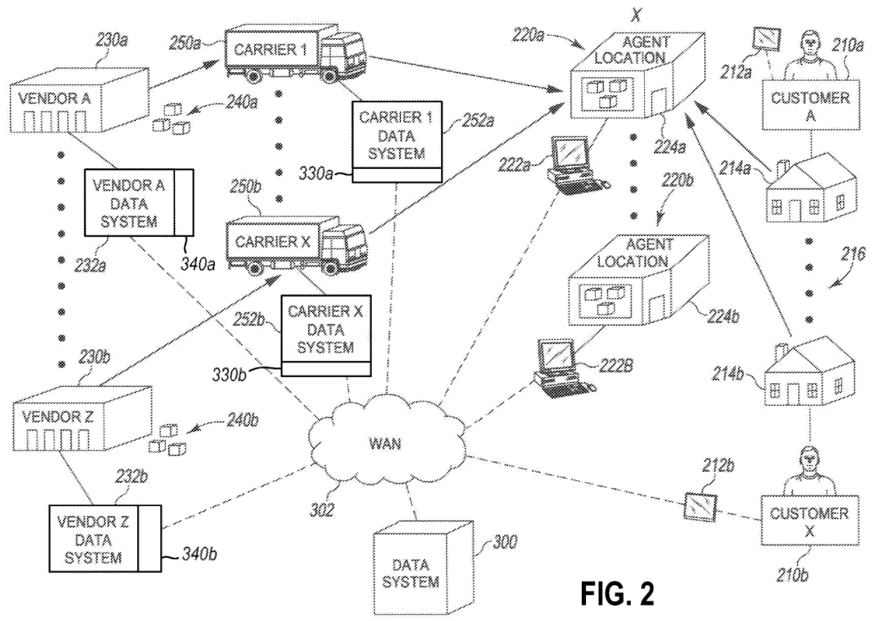

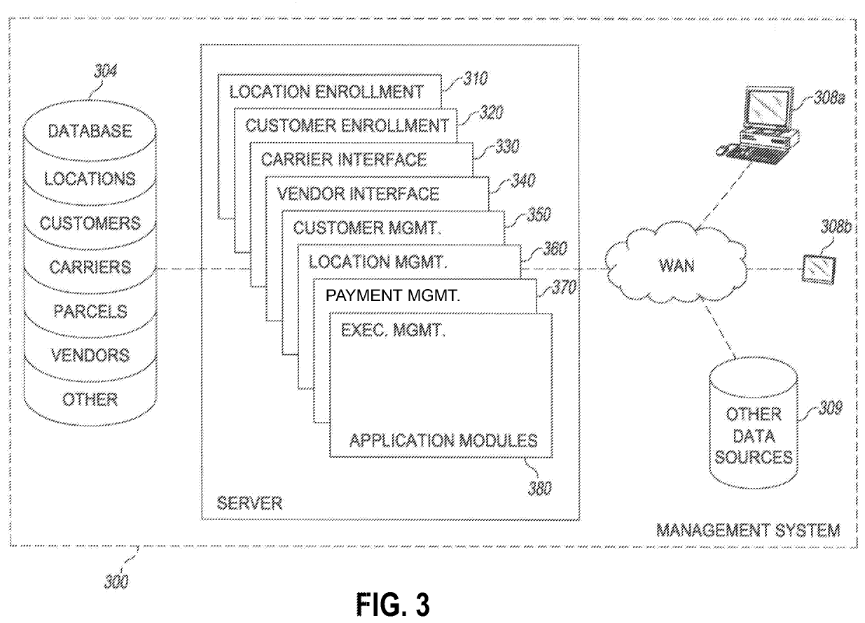

Referring to FIG. 2, an illustrative embodiment of a parcel management data communication system 200 according to the present disclosure is shown. The system 200 and associated methods (discussed below) provide improved and consolidated tracking and delivery of shipped parcels. The system 200 advantageously provides selective consolidation of carrier 250a-b delivery of parcels 240a-b for multiple customers 210a-b to receiving agent locations 220a-b in accordance with each one of the customer's selection of a receiving agent location 220a or 220b, and selection to use the consolidation while ordering goods for delivery by parcel using a third-party vendor data system 232, as will be described further below. Referring briefly to FIGS. 2 and 3, the system 200 can include parcel management data processing system 300 that can include a secure database 304 and at least one processor 306, for example, one or more servers, that executes various application modules 310-380.

The system 200 advantageously can use a single customer enrollment (discussed further below) to enable the customer to manage parcels shipped by multiple vendors 230a-b and delivered by multiple carriers 250a-b. Additionally, a single receiving agent location enrollment (discussed further below) can enable the receiving agent location 220a or 220b to receive parcels for multiple customers 210a-b delivered by multiple carriers 250a-b and shipped by multiple ecommerce and other vendors 250a-b. The result is an advantageous B to C (business to consumer) logistics conversion to B to B (business to business) to provides reduced labor and costs with consolidation of deliveries to a high density business, and morning delivery in most cases.

Additionally intermediary data interfaces 330 and 340 can be provided to carrier data systems 252a-b and to vendor data systems 242a-b, for example via a data communication networks, for example, a wide area network (WAN) 302, including for example the Internet, to help enable the advantageous functionality discussed herein that overcomes technical shortcomings with various prior art systems. For example, vendor data interface 340 may include an API or other software tool, for example optionally executed by a processor (not shown) of vendor data system 232, that provides the customers 210a-b selection of delivery using system 200 as part of the ordering process on the vendor data system 232, including for example the vendor's ecommerce website or other device application. For example, the vendor data interface 340 enables the customers 210a-b to specify one of the receiving agent locations 220 as the delivery location for the order being placed with the vendor 230. For example, the vendor data interface 340 may enable the customers 2010a-b to be redirected from the vendor data system 232 to the vendor module of system 200 for the delivery location selection, or the vendor data interface may provide a GUI within the vendor's ecommerce web site or other device application to enable the selection, or the interface may provide data exchange between a customer device 112 and vendor data system 232 and optionally server 306 to enable the delivery selection using the vendor data system. Similar implementation features as discussed for vendor data interface 340 may be applied to the other modules and interfaces disclosed herein.

Using system 200, customers 210a-b can manage their delivery of parcels 240a-b, including locations 220a-b, and access historic, current, and forecast data, for example, that can be stored in secure database 304 and is associated with the customer's transactions and parcels. Using system 200, receiving agent locations 224a-b can select and display historic, current, and forecast data, for example, data stored in database 304, including but not limited to data relating to parcels from multiple vendors 230a-b, carriers 250a-b, and customers 210a-b.

Referring to FIG. 3, an illustrative parcel management data processing system 300 portion of system 200 is shown. The data processing system 300 can include a secure database 304 and at least one processor 306, for example, one or more servers, that executes various application modules 310-380. The database 304 may be formed by using various types of structure and architecture as is known in the art. For example, the database may use hierarchical, relational, object-oriented, network, and/or other structures known in the art. Additionally, the physical architecture may include a single storage device with backups, a distributed data warehouse involving multiple devices and processors, cloud computing resources, or other hardware arrangements known in the art. Similarly, processor 306 may be a single server operating application modules 310-380, may be multiple servers/processors, and/or may have various portions of each of modules 310-380 distributed across various processors in various physical locations, using local networks, and/or the wide area network 302 for connectivity.

Additionally, application ‘modules’ is a term used for purposes of this disclosure for related structural and/or functional components of the system 200 and data system 300 that can be implemented using a combination of hardware and/or software. As such, the application modules as embodied in software and hardware may or may not be divided into distinct ‘modules’ depending on the software development environment and other aspects of the environment and architecture used to implement any particular embodiment. For example, processors implementing all or portions of software application modules 310-380 can include, for example, not only processor 306 but processors associated with one or more of computing device 308a and handheld computing device 308b, for example a smart phone or tablet device, including for example, customer devices 212b, agent location devices 222a-b, carrier data systems 252a-b, and vendor data systems 232a-b, each of which may use different types of software application environments that embody portions of or the entire modules, including for example, but not limited to, mobile and web-based apps and application programming interfaces (APIs). The various modules, data interfaces, data systems, database, and processors of system 200 and system 300 are capable real-time data communication and data management.

The various application modules include location enrollment 310, customer enrollment 320, carrier interface 330, vendor interface 340, customer management 350, location management 360, payment management 370, and executive management 380. Each of the application modules 310-380 will be discuss further below in the context of both illustrative methods and illustrative user interfaces associated with systems 200 and 300 and particular application modules. The portion of or entire module operating on one of the processors associated with the customer devices 212b, agent location devices 222a-b, carrier data systems 252a-b, and vendor data systems 232a-b may provide communication with the server 306, display on the individual devices, and optionally other data processing enabling system functionality described herein depending on whether the centralized or distributed data processing architecture is used.

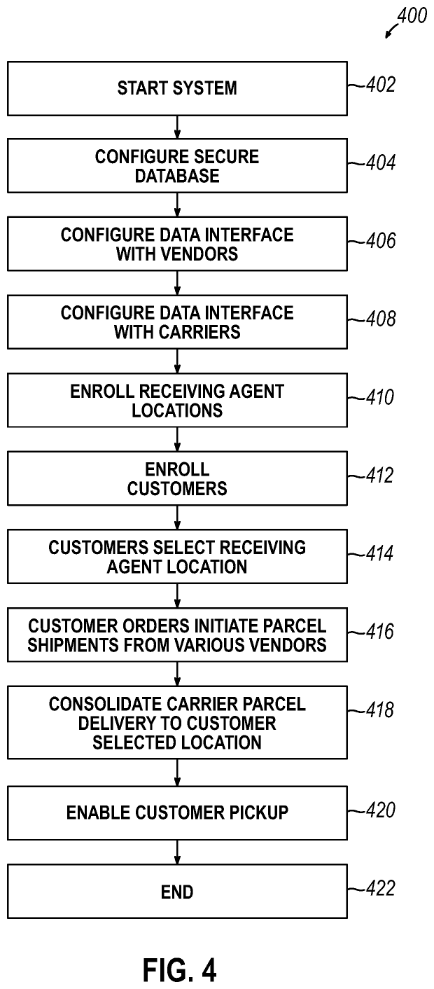

Referring to FIG. 4, an illustrative method 400 for consolidating tracking and delivery of parcels, according to the present disclosure, is shown. At step 402, the data system 300 begins method 400. Method 400 may also involve other components of data communication system 200, including those shown in FIG. 2, and GUIs associated with application modules 310-380.

At step 404 a secure database 304 is configured. Aspects of the database 304 are discussed above and below.

At step 406, a vendor data interface 340 is configured, enabling processor 306 to receive and optionally to send data to the vendor data systems 232a-b (FIG. 2), for example, via WAN 302. Data received by vendor data interface 340 includes information relating to the order of goods shipped in parcels 240a-b, including cost, tax, identity of goods, and parcel information, including possible carrier information as indicated below in step 408, including for example, carrier tracking number, and fulfillment status.

At step 408, a carrier data interface 330 is configured, enabling processor 306 to receive and optionally to send data to the carrier data systems 252a-b (FIG. 2), for example, via WAN 302. Data received via carrier data interface 330 includes information relating to the status of transport of parcels 240a-b, including tracking number, receipt by carrier, enroute status, logged locations and times, estimated delivery, and the like, and may also include descriptive information about the parcel 240a or 240b, including for example, size, weight, packaging, shipping service level, and the like.

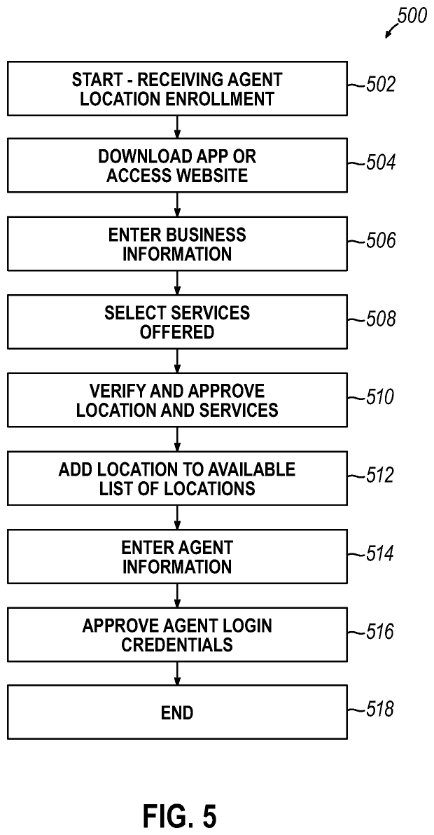

At step 410, the data system 300 enrolls receiving agent locations 220a-b, as illustrated by illustrative method 500 illustrated in FIG. 5 and discussed further below.

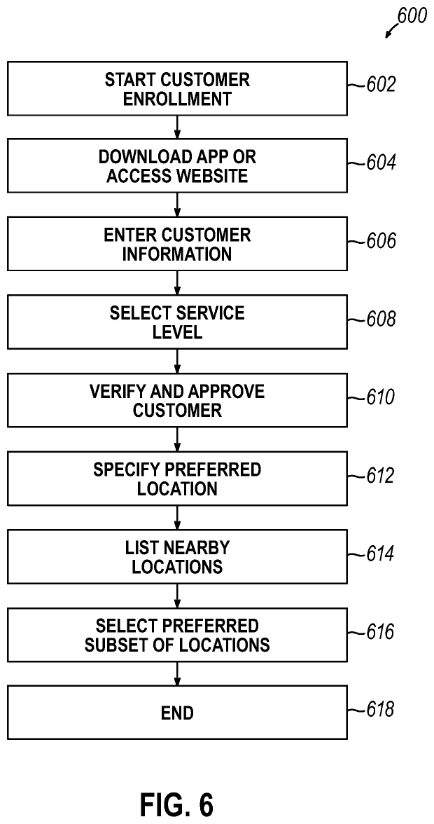

At step 412, the data system 300 enrolls customers 210a-b, as illustrated by illustrative method 600 illustrated in FIG. 6 and discussed further below.

At step 414, the data system 300 enables each of the customers 210a-b to select a preferred one of the agent locations 220a-b to receive parcels 240a-b shipped to the customer and to hold for customer pickup, or for further instructions from the customer, as is further discussed below.

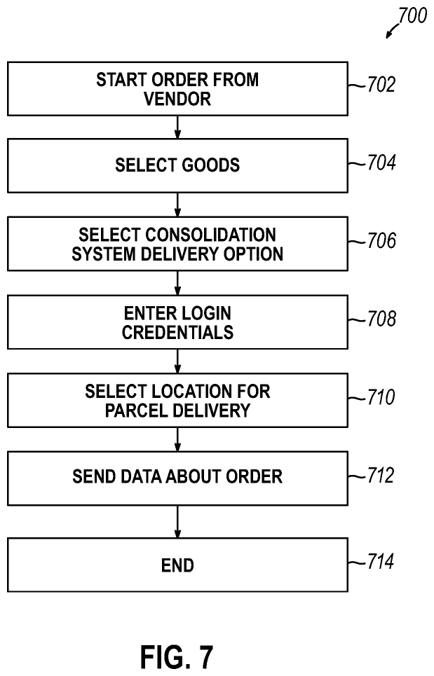

At step 416, at least one of the customers 210a-b orders goods from at least one vendor 230a-b, initiation shipment of parcels 240a-b, whether or not the at least one vendor is participating in the data system 300, for example, with vendor interface 340 and/or by method 700 illustrate in FIG. 7 and discussed further below.

At step 418, shipment of parcels 240a-b for each particular customer 210a-b having selected a particular agent location 220a or 220b are consolidated by delivery by the carriers 250a-b to the particular agent location 220a or 220b, rather than delivery to the customer residences 214a-b or other low density 216, including as enabled by methods 500, 600, and 700 discussed further below.

At step 420, the data system 300 enables customer pickup of parcels 240a-b at their selected agent location 220a-b, including as enabled by methods 500 and 600 discussed further below. At step 422, the illustrative method 400 for consolidating tracking and delivery of parcels is complete.

Referring to FIG. 5, an illustrative method 500 for enrollment of receiving agent locations 220a-b is shown. At step 502, the data system 300 begins the method 500. Method 500 may also involve other components of system 200, including those shown in FIG. 2, and GUIs associated with application modules 310-380, particularly the location enrollment module 310.

At step 504, authorized personnel (not shown) associated with a facility 224a or 224b, such as a retail business desiring to become a receiving agent location for the parcel management data communication system 200, use a computer device 222a, for example a computer or handheld computing device such as a smart phone or table, to access the remaining steps of the enrollment process, for example by downloading and accessing a compatible device app associated with the data system 300, or by accessing a location enrollment portion of a website, for example, served by processor 306.

At step 506, the authorized personnel provide pertinent and requested business information relating to facility 224a. At step 508, the authorized personnel provide the selected subset of services associated with system 200 to be offered by the facility 224a, for example, by selecting from a list of preset levels of service.

At step 510, the data system 300 verifies particular elements of the business information provided at step 506 and approves or denies the request to provide the subset of services at the facility 224a. If approved, in step 512 the facility 224a becomes a receiving agent location 220a and is added to the list of available locations 220a-b, for example, as stored and accessible from database 304, for example, as shown in illustrative GUIs of FIG. 24. In step 514, the authorized personnel enter information for employees who will serve as agents at location 220a, for example, as shown in illustrative GUIs of FIG. 24. At step 516, agent login credential are approved, for example, after an optional review by authorized personnel associated with facility 224a and/or associated with the management of data system 300 (not shown). At step 518, the method 500 for enrollment of receiving agent locations 220a-b is complete.

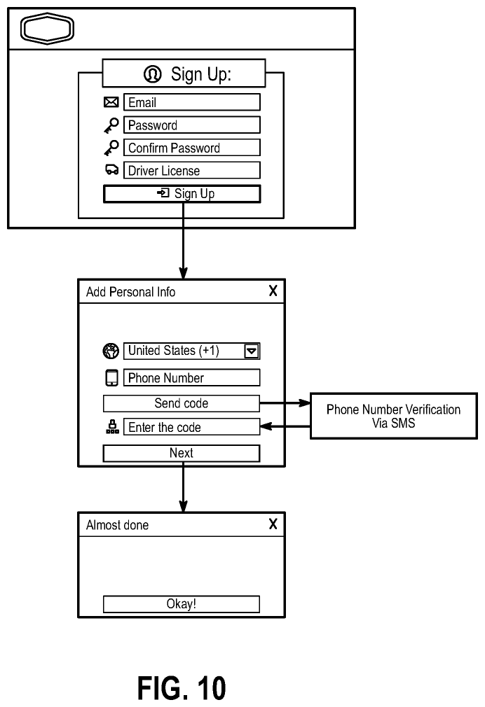

Referring to FIG. 6, an illustrative method 600 for enrollment of customers is shown. At step 602, data system 300 begins the method 600. Method 600 may also involve other components of system 200, including those shown in FIG. 2, and GUIs associated with application modules 310-380, particularly customer enrollment module 320, payment management module 370, and illustrative GUIs depicted in FIGS. 10-12.

At step 604, a prospective customer 210a or 210B associated with residence 214a or 214b desiring to use system 200 and 300 use a computer device 212a or 212b, for example a computer or handheld computing device such as a smart phone or table, to access the remaining steps of the enrollment process, for example by downloading and accessing a compatible device app associated with the data system 300, or by accessing a customer enrollment portion of a website, for example, served by processor 306.

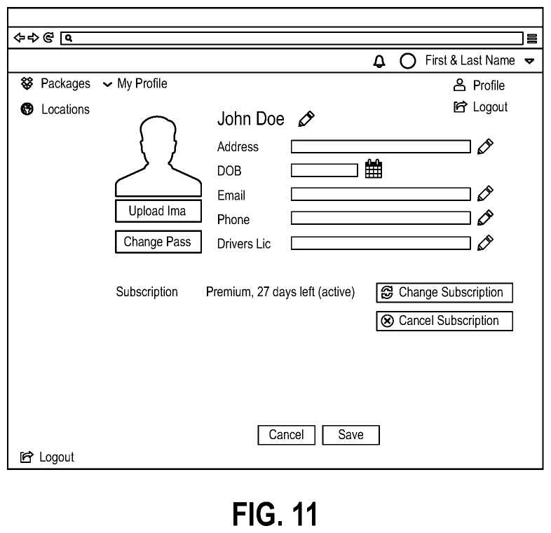

At step 606, the prospective customer 210a provides pertinent and requested information, for example, as illustrated in the GUIs of FIG. 10. At step 608, the prospective customer selects a subset of services associated with system 200 they desire to use, for example, by selecting from a list of preset levels of service, for example, as illustrated in the GUIs of FIG. 11.

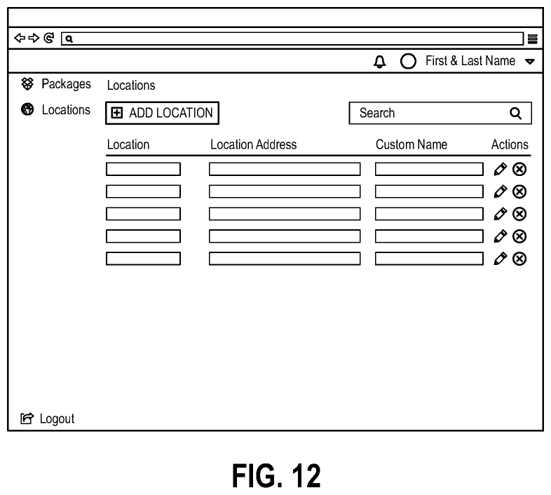

At step 610, the data system 300 verifies particular elements of the prospective customer 210a information provided at step 606 and approves or denies the enrollment and service level, for example, but not exclusively, based on payment and or credit information for prospective customer 210a, optionally including accessing and considering other data sources 309 available from third parties, for example, such as a credit reporting agency. If approved, in step 612 the enrolled customer 210a specifies a preferred location around which to locate and select from a list of available receiving agent locations 220a-b, for example, as stored and retrieved from database 304. For example, step 612 can use the location of residence 214a for customer 210a or a GPS location provided by the customer's computing device 212a. In step 614, a list of nearby locations 220a-b is provided via computing device 212a. At step 616, the customer 210a selections one or more of the preferred subset of locations 220a-b at which to receive deliveries of parcels 240a-b, optionally including a default location 220a for receiving the parcels. For example, as illustrated in the GUIs of FIG. 12. At step 618, the method 600 for enrollment of customer 210a is complete.

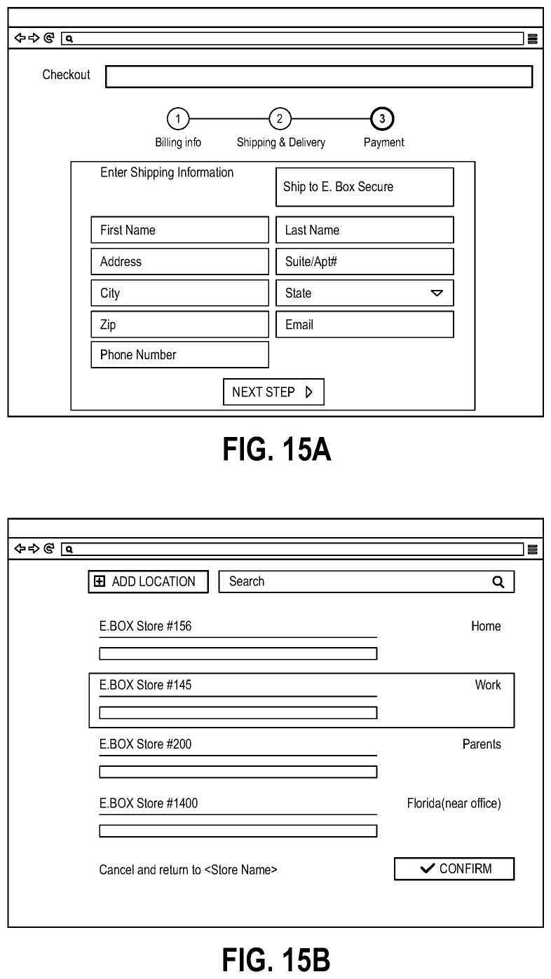

Referring to FIG. 7, an illustrative method 700 for ordering from a vendor 230a-b that includes elements of data system 300 is shown. At step 702, data system 300 begins the method 700. Method 700 may also involve other components of system 200, including those shown in FIG. 2, and GUIs associated with application modules 310-380, particularly location vendor interface module 340, customer management module 350, and the GUIs illustrated in FIG. 15.

At step 704, a customer 210a or 210b accesses a website or app of one of the ecommerce vendors 230a-b, for example, using computing device 212a and vendor data system 232a, to select goods for purchase and shipment.

At step 706, the customer 210a proceeds to a checkout and/or shipping step of the transaction using the vendor's website or app and selects an offered options to associate the transaction with the data system 300, providing the customer 210a management of and access to data associated with the transaction and subsequent shipping and delivery of parcels via the data system 300. At step 708, the customer 210a enters login credentials associated with data system 300 if the vendor's website or app offers this option. Step 708 may be offered in place of or before step 706. At step 710, the customer 210a may allow the delivery location for the parcel to be that earlier selected as a default for one of locations 220a or 220b, or may select a new location from the customer's selected sublist of locations 220a-b.

Upon completion of the transaction, data system 300 receives and stores data associated with the transaction, for example, received view vendor interface 340 and/or carrier interface 330 and stored in database 304. At step 714 the method 700 for ordering from a vendor 230a-b that includes elements of data system 300 is completed.

Even if a vendor's website or app does not incorporate and accommodate some of the steps of the method 700, for example, step 706 and/or step 708 offering an option to associate the transaction with the data system 300, the customer 210a may still have access to some aspects of management and data associated with the transaction and shipping and delivery of the parcels via the data system 300. For example, by providing the a tracking number for the parcels to data system 300, data system 300 can interact with a data system 252a or 252b of the carrier 250a or 250b providing transportation regarding the parcels. Additionally, the customer 210a may also provide to the vendor's website or app as a delivery address the customer's preferred one of the locations 220a or 200b.

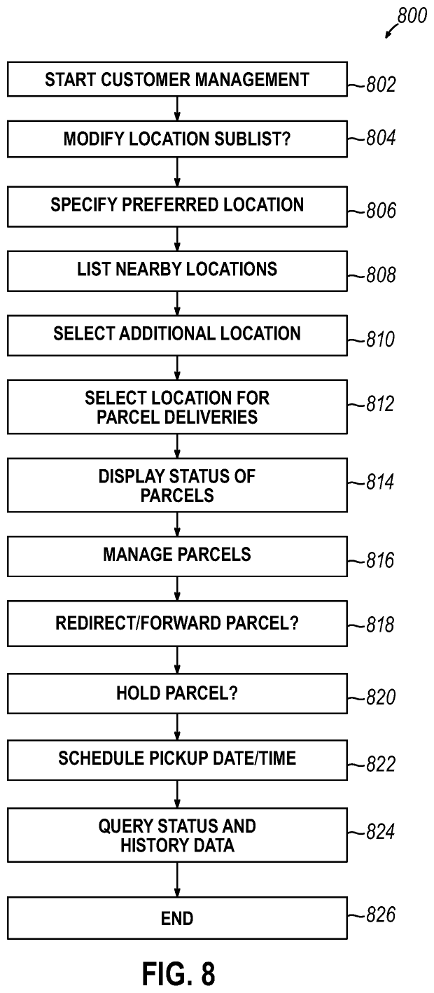

Referring to FIG. 8, an illustrative method of customer management for the illustrative method of FIG. 4 is shown. At step 802, data system 300 begins the method 800. Method 800 may also involve other components of system 200, including those shown in FIG. 2, and GUIs associated with application modules 310-380, particularly customer management module 350 and the GUIs illustrated in FIGS. 12-14.

At step 804, a customer 210a-b can chose to modify a selected list of preferred locations 220a-b to receive delivery of parcels, for example, via the customer's computing device 212a-b, for example, as illustrated in the GUIs of FIG. 12. For example, the customer 210a-b can choose to remove one or more existing location 220a-b from their selected list. Additionally, the customer 210a-b can choose to add one or more existing locations 220a-b to their preferred list of locations for delivery. If so, in step 806 the customer 210a-b can specify a preferred location around which to locate and select from a list of available receiving agent locations 220a-b, for example, as stored and retrieved from database 304. For example, step 806 can use the location of residence 214a for a customer 210a or a GPS location provided by the customer's computing device 212a. In step 808, a list of nearby locations 220a-b is provided via computing device 212a. At step 810, the customer 210a selects one or more of the preferred subset of locations 220a-b at which to receive deliveries of parcels 240a-b. At step 812, the customer 210a-b can select a one of the list of preferred locations 220a-b selected by the customer to be a default location 220a for receiving the parcels.

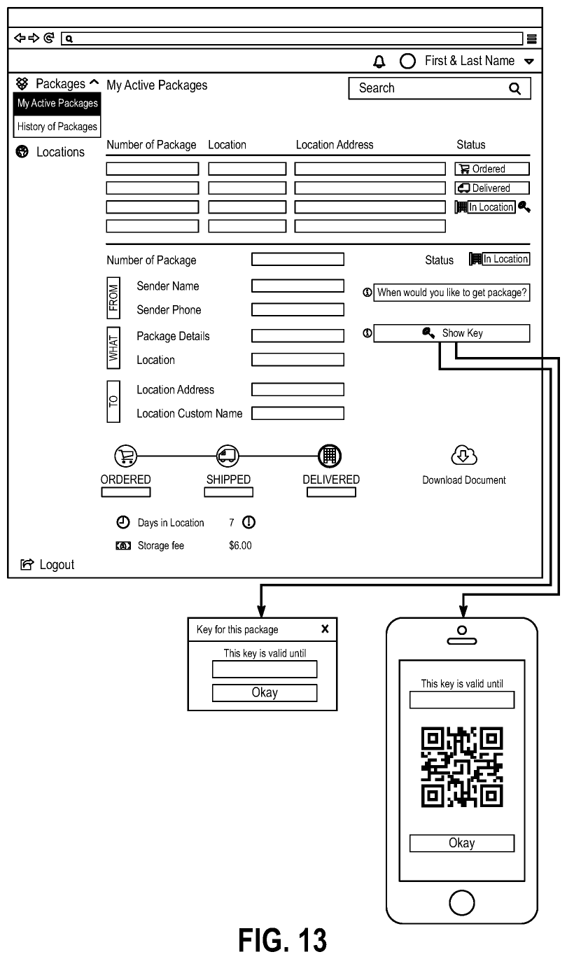

At step 814, a customer 210a can select to display a status of parcels 240a-b and/or transactions included in the database 304 for the customer, for example, via the customer's computing device 212a, for example, as illustrated in the GUIs of FIG. 13. At step 816, the customer 210a can manage one or more of the parcels 240a-b. For example, at step 818 the customer 210a can chose to redirect or forward deliver of parcel 210a to a location different from a specified delivery location 220a, for example, by specifying delivery to location 220b or residence 214a. Redirection may occur after method 700 for ordering from a vendor 230a-b has been completed, but before the parcel has been picked by a carrier 250a, after the parcel has been picked up from the vendor by the carrier, or after the parcel has been delivered by the carrier to the earlier selected delivery location 220b. Also, redirection may include system 300 interacting with carrier data system 252, including controlling automated parcel routing and handling equipment to redirect the parcel 210a from an original routing to the early delivery location to a new routing for the new delivery location. Also, redirection may include system 300 interacting with similar automated parcel routing and handling equipment of the vendor 230a or agent location 220a to redirect parcel 210a.

Additionally or alternatively, at step 820 the customer 210a can direct that location 220a or a carrier 250a or a vendor 230a hold one or more parcels 240a. Additionally or alternatively, at step 822 the customer 210a can specify a date and time of planned pickup of one or more parcels 240a from a location 220a, thereby providing notice to the agent(s) of the location 220a when to expect customer 210a.

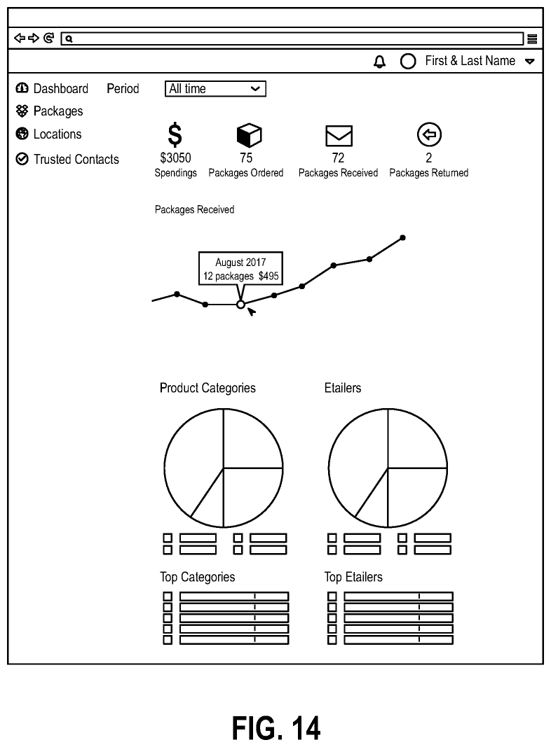

At step 824 the customer 210a can query, view, and/or export current, historic, or forecast data associated with the customer, for example, data stored in database 304, including but not limited to data relating to transactions with and parcels from multiple vendors 230a-b and carriers 250a-b and data system 300, for example, as illustrated in the customer dashboard GUI of FIG. 14.

At step 826, the method 800 for customer management is complete.

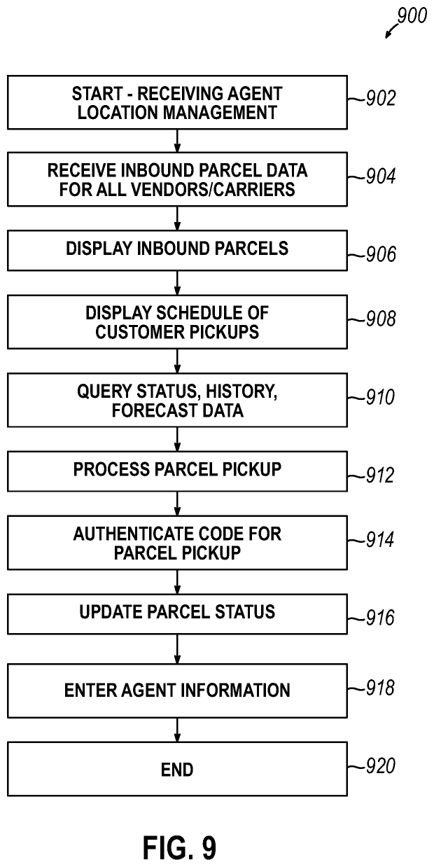

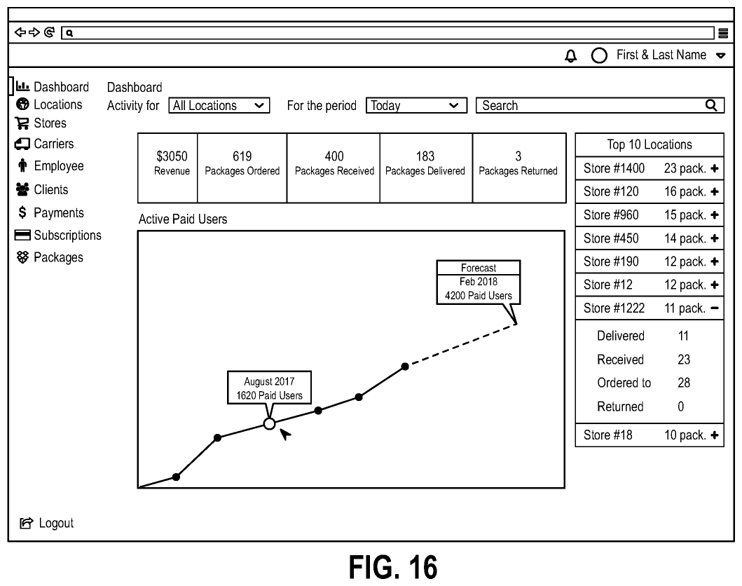

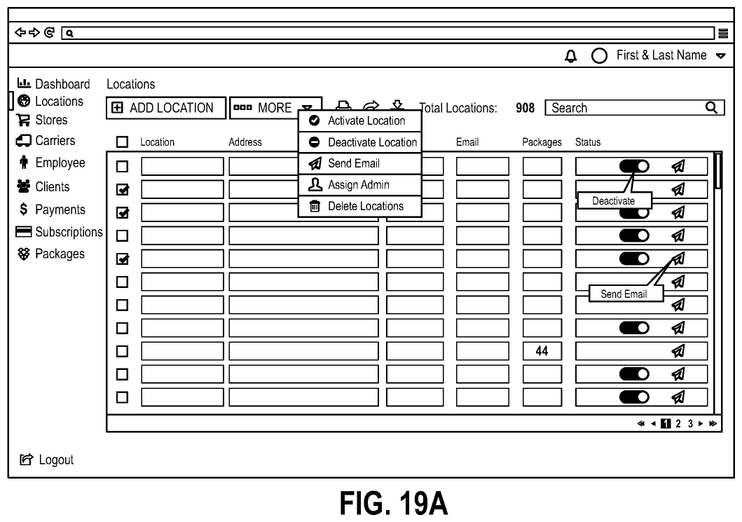

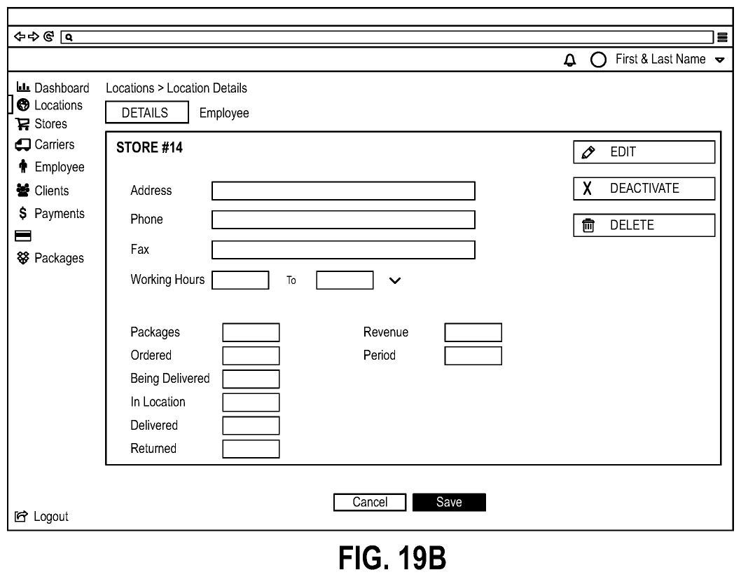

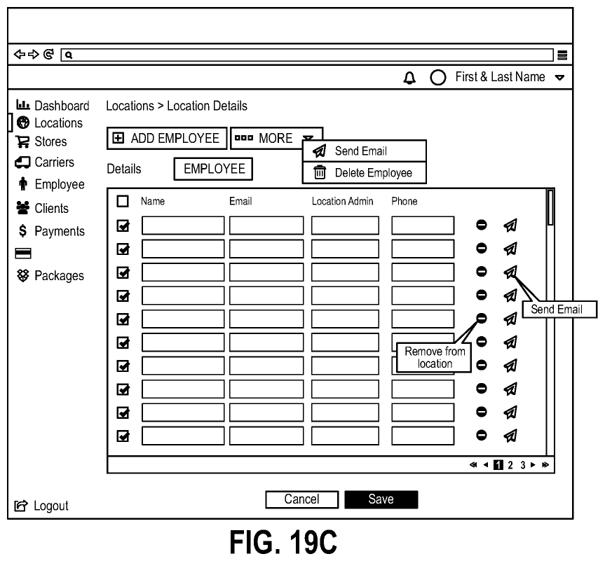

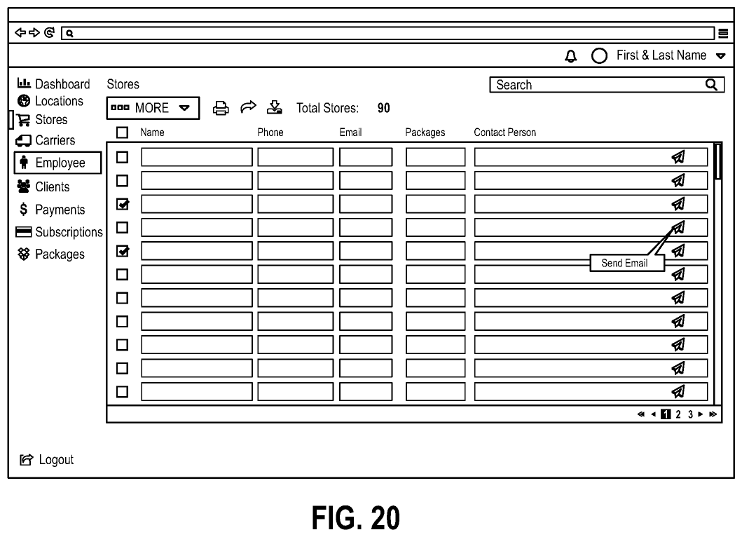

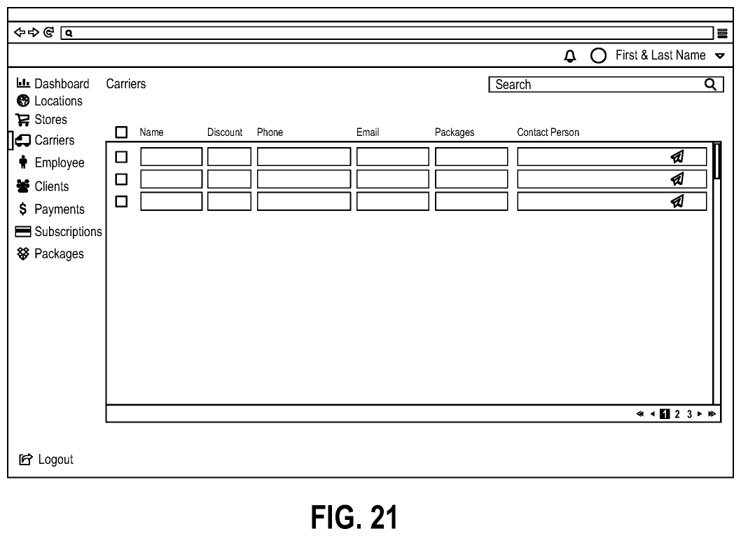

Referring to FIG. 9, an illustrative method 900 for agent location management for the illustrative method of FIG. 4 is shown. At step 902, data system 300 begins the method 900. Method 900 may also involve other components of system 200, including those shown in FIG. 2, and GUIs associated with application modules 310-380, particularly location management module 360 and illustrative GUIs in FIGS. 16-22.

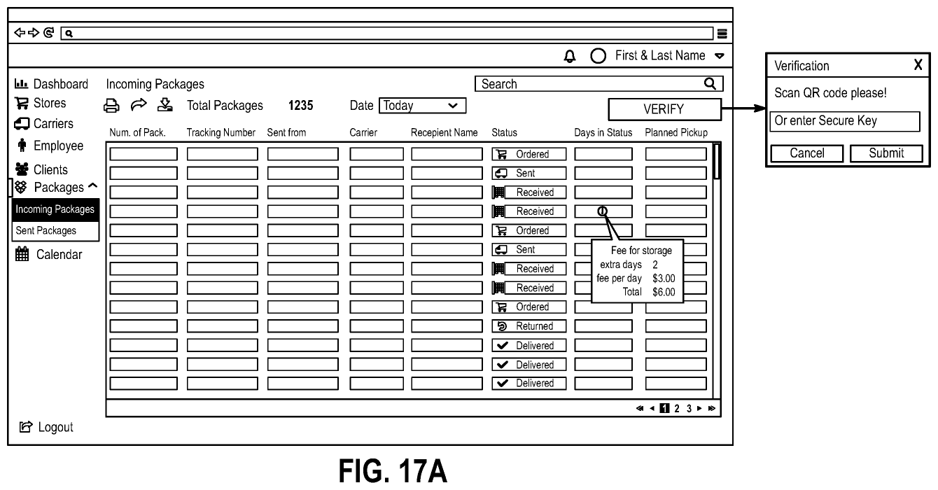

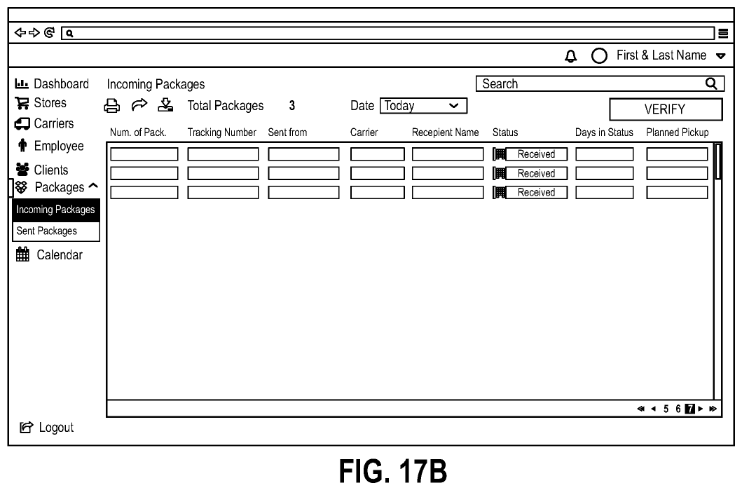

At step 904, the data system 300 can receive data relevant for locations 220a-b, including data from vendor data systems 232a-b via vendor interface 340, from carrier data systems 252a-b via carrier interface 330, and customer related data, for example, data stored in database 304. For example and more specifically, at step 906 each receiving agent location 220a-b can display on their computer device 222a-b data relating to parcels 240a-b that have been directed to their particular location 220a by the selection of the customer 210a-b for whom the parcels are shipped, for example, as illustrated in the GUIs of FIGS. 17A-B.

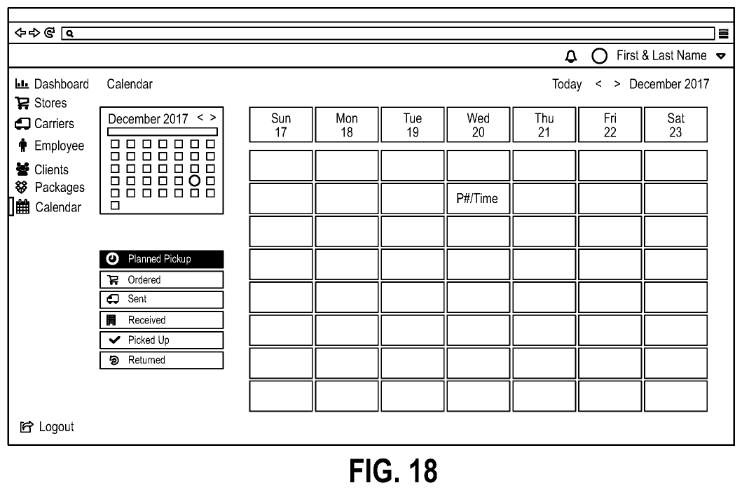

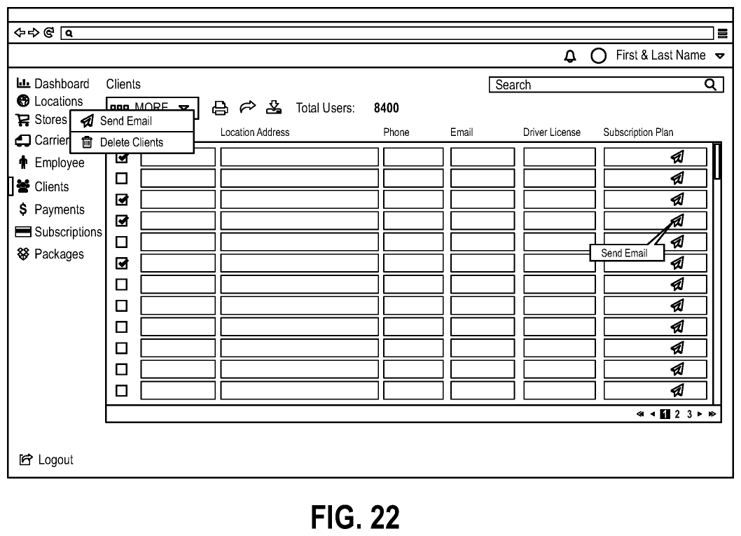

At step 908, each receiving agent location 220a-b can display a schedule or other listing on their computer device 222a-b of customers having inbound or arrived parcels in that location and the date and time the customer has selected, if any, for pickup, for example, as shown in the illustrative GUI of FIG. 18. At step 910, a receiving agent location 220a-b can use their computer device 222a-b to query current, history, and forecast data relating to parcels 240a-b that have been directed to their particular location 220a by the selection of the customer 210a-b for whom the parcels are shipped, for example, as shown in the illustrative dashboard GUI of FIG. 22.

At step 912, a receiving agent location 220a-b can use their computer device 222a-b to process one or more parcels 240a-b that a customer 210a-b is picking up from a location 220a-b. For example, at step 914, the receiving agent location 220a-b can use their computer device 222a-b to process an authentication code, for example a QR code, or customer ID to identify, verify, and provide one or more parcels 240a-b that a customer 210a-b is picking up from a location 220a-b, for example, as shown in illustrated GUI shown in FIGS. 13 and 17B.

At step 916, the data system 300 will update the status of the pickup parcels 240a-b, for example, update the data relating to the parcels that is stored in the database 304, and optionally provide status update information to one or more of vendor 232a-b, carrier 250a-b, and customer 210a-b connected to the one or more parcels. At step 920, the method 900 for agent location management is complete.

While examples, one or more representative embodiments and specific forms of the disclosure have been illustrated and described in detail in the drawings and foregoing description, the same is to be considered as illustrative and not restrictive or limiting. For example, software and hardware combinations may take many forms; therefore, processors, servers, networks, computing devices, applications, modules, and the like may be applied using alternative hardware and software structures, organization, and forms providing the same disclosed and/or claimed functions as the illustrative embodiments. The description of particular features in one embodiment does not imply that those particular features are necessarily limited to that one embodiment. Some or all of the features of one embodiment can be used in combination with some or all of the features of other embodiments as would be understood by one of ordinary skill in the art, whether or not explicitly described as such. For example, the order of steps in various illustrative methods can be maintained in some embodiments, reordered in other embodiments, steps can be omitted, other steps typical and known in the art may be added to a method, and another method or some steps of another method may be completed between steps of an illustrative method. One or more illustrative embodiments have been shown and described, and all changes and modifications that come within the spirit of the disclosure are desired to be protected.

### ELEMENT NUMBERING

The below list includes element numbers and at least one word used to describe the member and/or feature represented by the element number. It is understood that none of the embodiments disclosed herein are limited to these descriptions, other words may be used in the description or claims to describe a similar member and/or feature, and these element numbers can be described by other words that would be understood by a person of ordinary skill reading and reviewing this disclosure in its entirety.

100 Example prior art system

110 Customer

112 Customer device

114 Customer residence

116 Low density delivery area

130 Vendor

132 Vendor data system

140 Parcels

150 Carrier

152 Carrier data system

200 Parcel management data communication system

210 Customer

212 Customer device

214 Customer residence

216 Low density delivery area

220 Receiving agent locations

222 Location device

224 Location facility

230 Vendor

232 Vendor data system

240 Parcels

250 Carrier

252 Carrier data system

300 Parcel management processing system

302 Wide area network

304 Secure Database

306 Server (processor)

308 Devices (processors)

309 Other data sources

310 Location enrollment module

320 Customer enrollment module

330 Carrier interface module

340 Vendor interface module

350 Customer management module

360 Location management module

370 Payment module

380 Executive management module

What is claimed is:

1. A data communication system for managing parcel shipments for a plurality of customers and a plurality of receiving agent locations, comprising:
a secure database comprising data structures for storing data relevant to the parcel shipments, the plurality of customers, and plurality of receiving agent locations;
at least a first processor executing a customer enrollment module in communication with the database and providing a single enrollment of one of the plurality of customers to enable selection by each of the plurality of customers of a preferred one of the plurality of receiving agent locations to receive delivery of parcels shipped by a plurality of vendors and delivered by a plurality of carriers, the selection stored by the database;
at least a second processor executing a receiving agent location enrollment module in communication with the database and providing a single enrollment for one of the plurality of receiving agent locations to enable their receiving parcels for the plurality of customers, shipped by the plurality of vendors and delivered by the plurality of carriers; and
a vendor module having data communication interfaces with a plurality of vendor data systems of a plurality of vendors selling goods, the data communication interfaces in communication with the database and enabling each of the plurality of customers to select during a goods ordering process a preferred one of the plurality of receiving agent locations to receive delivery of parcels containing ordered goods; and
wherein the data communication system thereby selectively consolidates carrier delivery of parcels for the plurality of customers to the plurality of receiving agent locations in accordance with each one of the plurality of customers selection of one of the plurality of receiving agent locations stored by the database.

2. The data communication system of claim 1, further comprising a customer management module in communication with the database and providing customer interaction with the system to manage parcels shipped by the plurality of vendors and delivered by the plurality of carriers, including redirecting delivery of parcels to a different one of the plurality of receiving agent locations, the redirecting occurring after the goods ordering process was already completed.

3. The data communication system of claim 2, further comprising a receiving agent location management module in communication with the database and enabling each of the receiving agents locations to display inbound parcels and received parcels from the plurality of vendors and the plurality of carriers, and wherein redirecting delivery of parcels includes data communication with at least one of the plurality of receiving agent locations.

4. The data communication system of claim 2, further comprising a carrier module having data communication interfaces with a plurality of carrier data systems, the data communication interfaces in communication with the database, and wherein redirecting delivery of parcels includes data communication with at least one of the plurality of carrier data systems.

5. The data communication system of claim 2, wherein redirecting delivery of parcels includes data communication with at least the one of the plurality of vendor data systems with which the goods ordering process was completed.

6. The data communication system of claim 2, wherein the customer management module enables customer interaction that specifies for at least a period of time a different receiving agent location to have the parcels shipped to.

7. The data communication system of claim 2, wherein the at least first processor includes a device having a GPS, and the customer management module and database uses location information from the GPS to locate and display to one of the plurality of customers a selection the closest one of the plurality of receiving agent locations.

8. The data communication system of claim 2, wherein the customer management module enables one of the plurality of customers to schedule a date and time to pick up the parcel at the preferred one of the plurality of receiving agents.

9. The data communication system of claim 2, wherein the customer management module enables one of the plurality of customers to display order and parcel status and history for each of the plurality of customers.

10. The data communication system of claim 1, further comprising a receiving agent location management module in communication with the database and enabling each of the receiving agents to selectively display on a device for each of a plurality of customers and for all of the plurality of customers, the inbound parcels and received parcels from the plurality of vendors and the plurality of carriers.

11. The data communication system of claim 10, wherein the receiving agent location management module further enables display on the device the scheduled pickups of parcels by the plurality of customers.

12. The data communication system of claim 11, further comprising a customer management module in communication with the database and providing an authentication code to one of the plurality of customers for verification upon pickup of parcels, and wherein the receiving agent location management module further enables authentication code verification for pickup of parcels by the one of the plurality of customers.

13. The data communication system of claim 10, wherein the receiving agent location management module enables display of parcel status and history data for each of the plurality of receiving agent locations.

14. A data processing system for managing parcel shipments for a plurality of customers, a plurality of receiving agent locations, a plurality of vendors, and a plurality of carriers, comprising:
a processor in communication with a data communication network;
a secure database in communication with the processor and comprising data structures for storing data relevant to the parcel shipments, the plurality of customers, and plurality of receiving agent locations;
a customer enrollment module in communication with the database and providing a single enrollment of one of the plurality of customers to enable selection by each of the plurality of customers of a preferred one of the plurality of receiving agent locations to receive delivery of parcels shipped by a plurality of vendors and delivered by the plurality of carriers, the selection stored by the database;
a receiving agent location enrollment module in communication with the database and providing a single enrollment for one of the plurality of receiving agent locations to enable their receiving parcels for the plurality of customers, shipped by the plurality of vendors and delivered by the plurality of carriers; and
a vendor module in communication with the data communications network and data communications interfaces associated with each of a plurality of vendor data systems, the data communications interfaces enabling each of the plurality of customers to select during a goods ordering process a preferred one of the plurality of receiving agent locations to receive delivery of parcels containing ordered goods; and
wherein the data processing system thereby selectively consolidates carrier delivery of parcels for the plurality of customers to the plurality of receiving agent locations in accordance with each one of the plurality of customers selection of one of the plurality of receiving agent locations stored by the database.

15. The data processing system of claim 14, further comprising a customer management module in communication with data communication network and providing customer interaction with the system to manage parcels shipped by the plurality of vendors and delivered by the plurality of carriers, including redirecting delivery of parcels to a different one of the plurality of receiving agent locations, the redirecting occurring after the goods ordering process was already completed.

16. The data processing system of claim 15, further comprising a receiving agent location management module in communication with the data communication network and enabling each of the receiving agents locations to display inbound parcels and received parcels from the plurality of vendors and the plurality of carriers, and wherein redirecting delivery of parcels includes data communication with at least one of the plurality of receiving agent locations.

17. The data processing system of claim 15, further comprising a carrier module having data communications interfaces with a plurality of carrier data systems, the data communication interfaces in communication with data communication network, and wherein redirecting delivery of parcels includes data communication with at least one of the plurality of carrier data systems.

18. The data processing system of claim 15, wherein redirecting delivery of parcels includes data communication with at least the one of the plurality of vendor data systems with which the goods ordering process was completed.

19. The data processing system of claim 15, wherein the customer management module enables customer interaction that specifies for at least a period of time a different receiving agent location to have the parcels shipped to.

20. The data processing system of claim 15, wherein the customer management module operates at least in part on a customer device having a GPS, and the customer management module and database uses location information from the GPS to locate and display to one of the plurality of customers a selection the closest one of the plurality of receiving agent locations.

21. The data processing system of claim 15, wherein the customer management module enables one of the plurality of customers to schedule a date and time to pick up the parcel at the preferred one of the plurality of receiving agents.

22. The data processing system of claim 15, wherein the customer management module enables one of the plurality of customers to display order and parcel status and history for each of the plurality of customers.

23. The data processing system of claim 15, further comprising a receiving agent location management module in communication with data communication network and enabling each of the receiving agents to selectively display on a device for each of a plurality of customers and for all of the plurality of customers, the inbound parcels and received parcels from the plurality of vendors and the plurality of carriers.

24. The data communications system of claim 23, wherein the receiving agent location management module further enables display on the device the scheduled pickups of parcels by the plurality of customers.

25. The data communications system of claim 24, further comprising a customer management module in communication with the data communication network and providing an authentication code to one of the plurality of customers for verification upon pickup of parcels, and wherein the receiving agent location management module further enables authentication code verification for pickup of parcels by the one of the plurality of customers.

26. The data communications system of claim 23, wherein the receiving agent location management module enables display of parcel status and history data for each of the plurality of receiving agent locations.
